(19) United States
(12) Patent Application Publication
(10) Pub. No.: US 2025/0250107 A1
(43) Pub. Date: Aug. 7, 2025

(54) MOBILE STORAGE MODULE FOR SHEET STACKS, SYSTEM, AND OPERATING METHOD

(71) Applicant: Heidelberger Druckmaschinen AG, Heidelberg (DE)

(72) Inventors: Steffen Neeb, Bensheim (DE); Stefan Mutschall, Östringen (DE); Michael Östreicher, Eppelheim (DE); Markus Möhringer, Weinheim (DE)

(21) Appl. No.: 19/044,121

(22) Filed: Feb. 3, 2025

(30) Foreign Application Priority Data
Feb. 7, 2024 (DE) 10 2024 103 352.5

(51) Int. Cl. B65G 1/02; B65G 61/00

(52) U.S. Cl. CPC B65G 1/023; B65G 61/00

(57) ABSTRACT

A mobile storage module for sheet stacks during production and/or post press processing of printed products, includes at least one inclined storage surface being configured to store sheet stacks in a row and adjustable into horizontally different loading and unloading positions, preferably using a robot arm. A system includes a storage module, a first robot having a first robot arm loading the storage module and a second robot having a second robot arm unloading the storage module. A method includes moving the storage module to a working area of the first robot. The first robot loads a sheet stack onto a storage surface in its loading position, the storage module moves to the working area of the second robot, and the second robot unloads the storage surface in its unloading position. Sheet stacks are stored securely, transported and transferred between graphics machines, for example folding and stitching machines.

### CROSS-REFERENCE TO RELATED APPLICATION

This application claims the priority, under 35 U.S.C. § 119, of German Patent Application DE 10 2024 103 352.5, filed Feb. 7, 2024; the prior application is herewith incorporated by reference in its entirety.

### FIELD AND BACKGROUND OF THE INVENTION

The invention relates to a mobile storage module for sheet stacks in the production and/or post press processing of printed products, having at least one inclined storage surface configured to store a plurality of sheet stacks in a row. The invention also relates to a system including at least one mobile storage module and a method for operating such a system.

The invention is in the technical field of the graphics industry, in particular in the field of storing and transporting stacks of superposed, flexible and preferably printed and folded flat products such as, for example, signatures, preferably of paper, cardboard, paperboard, plastics or composite material, and loading and unloading stores using a manipulator, in particular a jointed-arm robot/articulated robot having a robot arm and a gripper device for the stacks.

### DESCRIPTION OF THE RELATED ART

Folding machines and downstream post processing machines with feeders are already known, for example gathering machines, binding machines and stitching machines. It is necessary to transport the folded sheets from one machine to the next and position them there. Transport is generally on pallets. Placing sheet stacks on pallets, picking them up again and positioning them by hand are labor-intensive, strenuous and time-consuming, which is why robots are already being used in this area. “Storing” and transporting the stacks on pallets can lead to further problems, such as stacks or individual sheets slipping or tipping over, for example. There is therefore a constant need for logistical improvements between and at the machines.

German Patent Application DE 10 2023 117 693 discloses such an improvement, namely lifting and storage modules, machines and a system and production method for handling folded sections. In that context, a mobile storage module for folded sections is also disclosed, which includes a plurality of storage surfaces disposed one above another. The storage surfaces are equipped with movable belts and can be inclined.

In addition, various types of transport trolleys for paper or other goods are known.

German Patent Application DE 353 1188 A1, corresponding to U.S. Pat. No. 4,763,965, discloses a movable paper carriage having a plurality of horizontal shelves, allowing a plurality of paper stacks to be received on each shelf.

Chinese Utility Model CN 217623687 U discloses a transport trolley with an inclined storage surface for receiving goods, with the goods automatically moving “downward” to a respective end position due to the inclination of the storage surface. For unloading, the goods have to be pushed “upward” again, for which purpose a corresponding device is provided. Chinese Utility Model CN 209618105 U discloses similar but with a plurality of storage levels one above another.

### SUMMARY OF THE INVENTION

It is accordingly an object of the invention to provide a mobile storage module for sheet stacks, a system, and an operating method, which overcome the hereinafore-mentioned disadvantages of the heretofore-known devices and methods of this general type and which provide an improvement over the prior art, in particular making it possible to store sheet stacks securely and to transport and transfer them between machines used in the graphics industry.

### Solution According to the Invention to the Problem

With the foregoing and other objects in view there is provided, in accordance with the invention, a mobile storage module for sheet stacks in the production and/or post press processing of printed products, comprising at least one inclined storage surface, the storage surface being configured to store a plurality of sheet stacks in a row, and the storage surface being adjustable into two different horizontal positions.

With the objects of the invention in view, there is also provided a system comprising at least one mobile storage module according to the invention, at least a first robot having a first robot arm for loading the storage module and at least a second robot having a second robot arm for unloading the storage module.

With the objects of the invention in view, there is concomitantly provided a method for operating a system according to the invention, which comprises the storage module being moved to the working area of the first robot, the first robot loading at least one sheet stack onto at least one storage surface in the loading position thereof, the storage module being moved to the working area of the second robot, and the second robot unloading the storage surface in the unloading position thereof.

Advantageous and therefore preferred developments of the invention emerge from the dependent claims and from the description and drawings.

### Advantageous Embodiments and Effects of the Invention

The invention (as a device or storage module, system and/or method) makes it possible in an advantageous manner to store sheet stacks securely and to transport and transfer them between machines used in the graphics industry. The invention is used for example between folding machines and stitching machines.

The invention offers, for example, the advantage that robots can be used for the loading and unloading and that the sheet stacks can be securely transferred, received, stored and transported. The storage surface to be loaded or unloaded can be moved, in particular displaced, into corresponding (loading and unloading) positions. In this respective position, it is readily accessible to the robot(s). During transport, the storage surfaces and thus the sheet stacks are in secure (intermediate) positions. The storage surfaces serve as shelves for sheet stacks to be stored in the production process. Surfaces equipped in each case with rollers, wheels or balls as support elements may be present; alternatively, surfaces equipped in each case with a belt or with a plurality of belts may also be present. The surfaces can also be configured as pure sliding surfaces without being equipped.

The respective storage surface is configured as an inclined storage surface (with or without side wall(s) or stop(s)) and, depending on the configuration, can also be referred to as an (inclined) storage level, as a storage tray, as a storage compartment or as a storage cassette. Since the respective storage surface is also movable, in particular displaceable, it can also be referred to as a storage drawer, depending on the configuration.

The sheet stacks to be stored are preferably formed by (loose) superposed sheets, for example of paper or cardboard, in particular by folded sheets or so-called signatures.

The robot arm is preferably part of a robot system, which usually also includes a robot base and which can be configured as a conventional industrial robot together with an enclosure for operator protection, in particular as a jointed-arm robot with three to seven axes of rotation, or as a so-called collaborative robot system, in particular as a so-called cobot. The latter does not require any enclosure, as the system has its own sensor system which it uses to detect contact with operating personnel and prevent possible injuries, for example by automatically stopping the robot arm movement. As an alternative to the cobot, a collaborative robot system can also be realized by an industrial robot with an additional area scanner (for detecting operating personnel in the danger zone) and an automatic stop function.

### Developments of the Invention

Preferred developments of the invention (for short: developments) are described below. These can also be combined with one another, where this is not technically excluded.

### Developments of the Storage Module

One development can be distinguished by the storage surface being adjustable to a first horizontal position. One development can be distinguished by the first horizontal position being a loading position. One development can be distinguished by sheet stacks being loadable onto the storage surface in the loading position. One development can be distinguished by the storage surface being adjustable to a second horizontal position (different from the first). One development can be distinguished by the second horizontal position being an unloading position. One development can be distinguished by sheet stacks being unloadable from the storage surface in the unloading position. One development can be distinguished by the loading position and the unloading position being provided opposite one another. “Different horizontal positions” means that the respective positions are different from one another with respect to a horizontal, that is to say, for example, “to the left” and “to the right” of the storage module (cf. the figures).

One development can be distinguished by the storage surface being lockable in the loading position (for example against unintentional displacement). One development can be distinguished by the storage surface being lockable in the unloading position. One development can be distinguished by the storage surface being lockable in an intermediate position between the loading position and the unloading position. One development can be distinguished by the presence of a catch for the respective locking. It can preferably be operated by the robot.

One development can be distinguished by the storage surface automatically adjusting from the loading position to an intermediate position and by the storage surface automatically adjusting from the unloading position to the intermediate position. One development can be distinguished by the at least partially loaded storage surface, under its own weight, automatically adjusting from the loading position to the intermediate position. One development can be distinguished by the automatic adjustment being triggered by a robot arm, a drive, or manually. For example, a robot can push or pull the storage surface out of the loading position or out of the unloading position and the storage surface can then automatically move or move further. One development can be distinguished by the presence of an end-of-travel damper for the storage surface in the unloading position.

One development can be distinguished by the presence of an actuator, which adjusts the storage surface from the loading position or from the unloading position to the intermediate position. One development can be distinguished by the actuator being at least one compression spring. One development can be distinguished by the actuator operating pneumatically, hydraulically or electrically. One development can be distinguished by the actuator being a robot arm. This solution is of particular advantage, since no other actuator is required except for the (already present) robot. One development can be distinguished by the storage surface being pushed. One development can be distinguished by the storage surface being pulled. The compression spring can be disposed between a frame of the storage module and the storage surface (movable relative thereto); it can assist the robot in pushing or pulling: the robot pushes the storage surface firstly (after loading) against the compression spring until the latter pivots due to its rotatable mounting and then pushes the storage surface onward; the same applies correspondingly in the opposite direction (after unloading).

One development can be distinguished by the movement from the first horizontal position to the second horizontal position being effected in the horizontal.

One development can be distinguished by the movement from the first horizontal position to the second horizontal position being effected in a direction inclined with respect to the horizontal.

One development can be distinguished by the storage surface including a longitudinal direction and a transverse direction. One development can be distinguished by the storage surface receiving a plurality of sheet stacks in the longitudinal direction. One development can be distinguished by the storage surface being inclined in the longitudinal direction. One development can be distinguished by the storage surface being inclined additionally in the transverse direction. The respective inclination improves (while simultaneously providing a correspondingly disposed stop for the sheet stacks) the secure storage and transport of the sheet stacks in a (singly or doubly) inclined position.

One development can be distinguished by the storage surface including at least one groove for receiving in each case one gripper tine. One development can be distinguished by the groove extending in the longitudinal direction or in the transverse direction of the storage surface. One development can be distinguished by the storage surface including at least one groove in the loading region for receiving in each case one gripper tine for the sheet stack. One development can be distinguished by the storage surface including at least one groove in the unloading region for receiving in each case one gripper tine for the sheet stack.

One development can be distinguished by the storage surface—at different positions in its longitudinal direction—being equipped with conveyor rollers (corresponding to the width of the storage surfaces), conveyor wheels (several next to one another along the width of the storage surface) or preferably conveyor balls for the sheet stacks. The rollers, wheels or balls preferably project somewhat, for example a few millimeters, beyond the support surface of the storage surface. One development can be distinguished by the conveyor rollers, conveyor wheels or conveyor balls being configured with brakes; in that case, the sheet stacks move in a braked manner and thus more securely along the storage surface. One development can be distinguished by the conveyor rollers, conveyor wheels or conveyor balls being configured with a freewheel; in that case, the sheet stacks move securely only in one direction along the storage surface and not back. One development can be distinguished by the storage surface being equipped with additional braking elements, for example small hooks.

One development can be distinguished by the storage module including a plurality of inclined storage surfaces. One development can be distinguished by the storage surfaces being disposed one above another (at different heights). One development can be distinguished by the storage surfaces being of identical configuration to one another. The storage module can in this case be in the form of a rack. Alternatively or in addition, it is also possible for a plurality of storage surfaces to be present next to one another (at the same height), in which case it is preferably possible for each storage surface to be moved back and forth separately.

One development can be distinguished by the storage module including casters for moving the storage module on a floor. One development can be distinguished by the storage module including at least one locking brake. One development can be distinguished by the storage module being configured to be moved by an AGV. The AGV can preferably drive under the storage module and lift it. For this purpose, the storage module preferably on at least one side has a corresponding opening near the floor. One development can be distinguished by the storage module being configured to be moved by a forklift truck. One development can be distinguished by the storage module being configured to be placed in a high-bay warehouse. For this purpose, the storage module may have corresponding rails or a base surface on its underside.

One development can be distinguished by the storage module having a frame in which at least one storage surface is displaceably mounted. The frame can be made of metal. Horizontal rails for the movable storage surfaces can preferably be attached to the frame, for example telescopic rails similar to those used in drawers.

One development can be distinguished by the sheet stacks including superposed folded sheets. One development can be distinguished by the storage module accepting sheet stacks from different production orders.

### Developments of the System

One development can be distinguished by the system including a docking module for the mobile storage module. The docking module can be fastened to a floor of the production facility. The docking module can be connected to the robot. One development can be distinguished by the docking module determining a positioning of the storage module relative to a robot. This ensures that the robot precisely places the sheet stacks into the storage module or receives them from there, and/or that the tines of a gripper for the sheet stacks are precisely inserted into the grooves of the storage surface. Teaching is then advantageously not necessary, since the dimensions and positionings of the modules involved (robot, storage module) are known and are available to a control computer for the robot. The movable storage module can latch in the docking module, for example with its transport casters, and be secured against unintentional movement.

### Developments of the Operating Method

One development can be distinguished by the first robot arm or the second robot arm adjusting the storage surface from the loading position to the intermediate position or triggering an automatic adjustment of the storage surface from the loading position to the intermediate position. One development can be distinguished by the first robot arm or the second robot arm adjusting the storage surface from the unloading position to the intermediate position or triggering an automatic adjustment of the storage surface from the unloading position to the intermediate position.

The features and combinations of features disclosed in the above sections covering the technical field, invention and developments and in the following section covering the exemplary embodiments represent—in any desired combination with one another—further advantageous developments of the invention.

Other features which are considered as characteristic for the invention are set forth in the appended claims.

Although the invention is illustrated and described herein as embodied in a mobile storage module for sheet stacks, a system, and an operating method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a preferred exemplary embodiment of a storage module according to the invention;

FIG. 2 is a side-elevational view of a preferred exemplary embodiment of a storage module according to the invention;

FIG. 3 is a side-elevational view of a preferred exemplary embodiment of a storage module according to the invention while being loaded using a robot; and

FIG. 4 is a side-elevational view of a preferred exemplary embodiment of a storage module according to the invention while being unloaded using a robot.

### DETAILED DESCRIPTION OF THE INVENTION

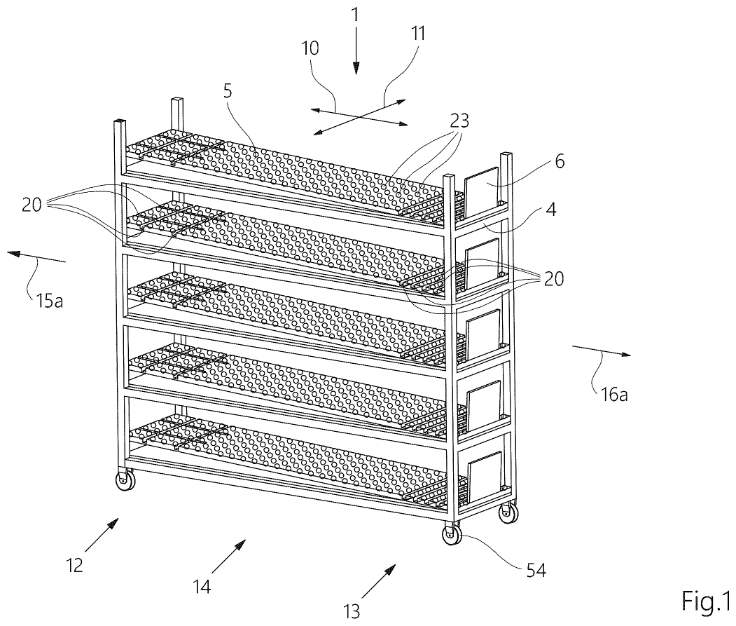

FIGS. 1 to 4 show preferred exemplary embodiments of the invention and of the developments thereof. Features corresponding to one another are provided with the same reference signs in the figures. Repeated reference signs in the figures have been omitted in some cases for the sake of clarity.

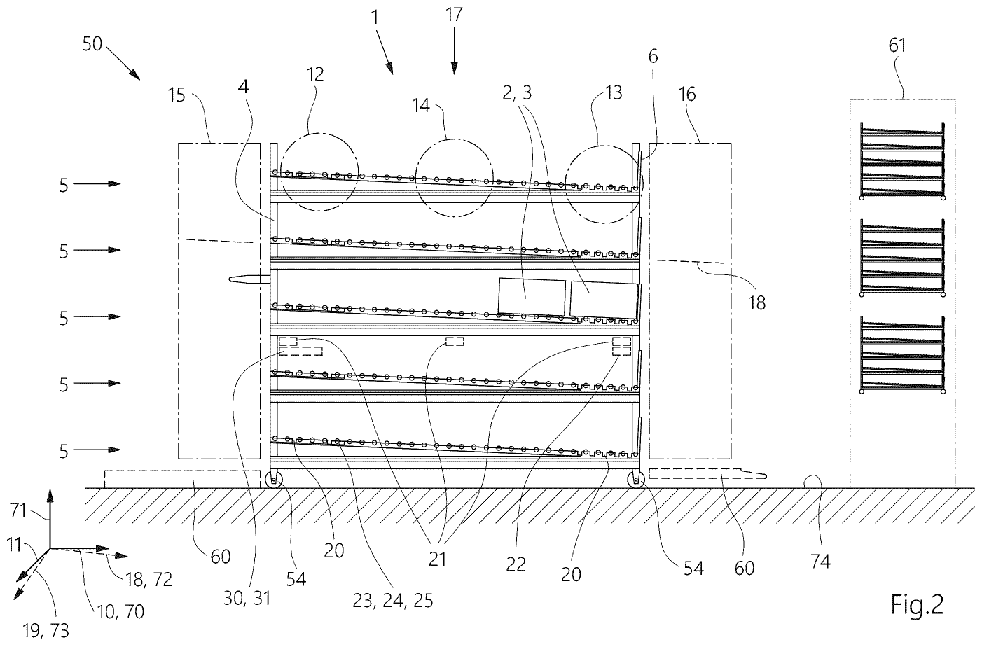

Referring now to the figures of the drawings in detail and first, particularly, to FIGS. 1 and 2 thereof, there is seen a mobile storage module 1 according to the invention for storing a plurality of sheet stacks 2 of superposed sheets 3 on different levels. The storage module 1 includes a frame 4 with a plurality of, in the illustrated example five, storage surfaces 5 or storage compartments. The storage module 1 has a rack-like structure. The individual storage surfaces 5 are disposed inclined in at least one direction 72 with respect to the horizontal 70; optionally additionally also transversely thereto in a direction 73 (first inclination 18 and optional second inclination 19 of a respective storage surface 5). The individual storage surfaces 5 are disposed one above another and at a distance (which defines the maximum height of the sheet stacks 2 to be stored) in the vertical 71. The storage module 1 can include casters 54 with which the storage module 1 can be moved, e.g. pushed by an operator, on a floor 74 of the production facility (for example a printing plant). The casters 54 themselves can be equipped with locking brakes. The storage module 1 has a longitudinal direction 10 and a transverse direction 11. In the longitudinal direction 10 or the direction 72 (slightly) inclined thereto, a plurality of sheet stacks 2 can be received and thus stored on a respective storage surface 5. The sheet stacks 2 are then located in different storage positions on the respective storage surfaces 5; that is to say, two or more sheet stacks 2 can be stored in a row on each storage surface 5. Due to the existing inclination 18, the storage module virtually occupies the respective storage surface 5 from “bottom to top” in terms of the sheet stack 2.

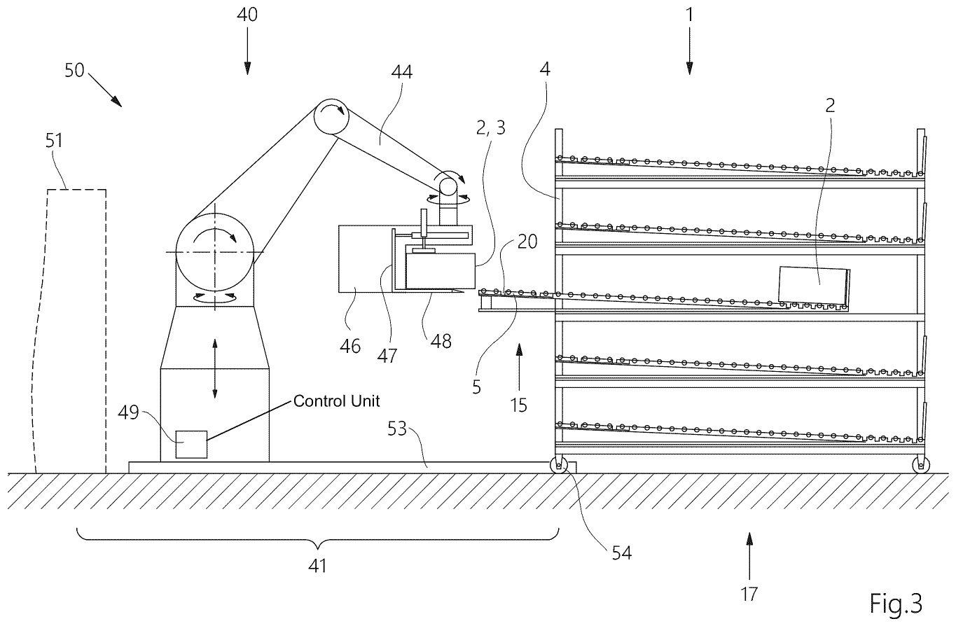

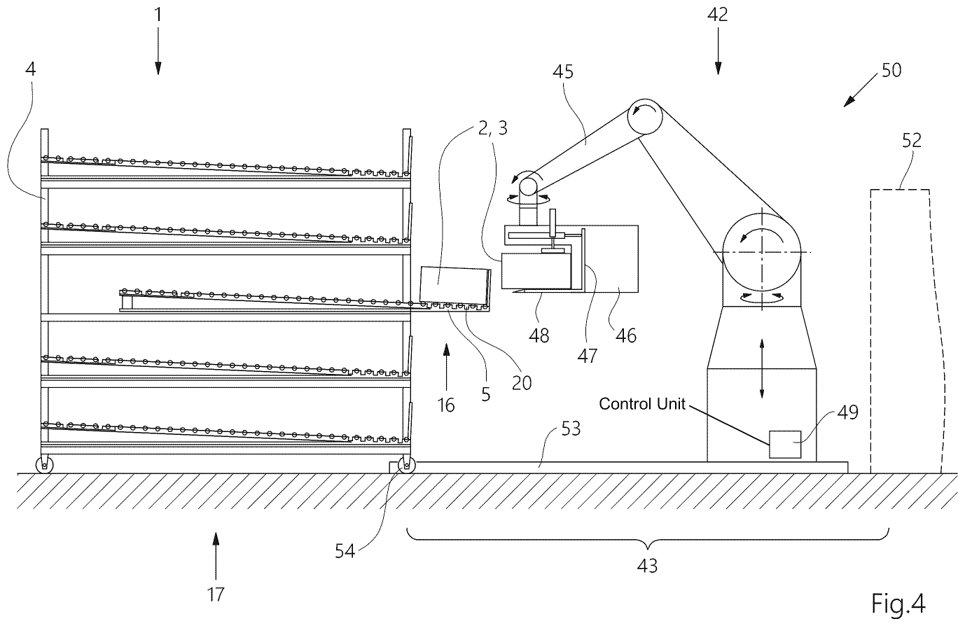

With regard to the loading, unloading and storage of sheet stacks 2, the storage module 1 includes a loading area 12, an unloading area 13 and, between them, a storage area 14, with it being possible for the storage area 14 to overlap with the loading area 12 and the unloading area 13. A respective storage surface 5 can be pushed or pulled into a first position 15 in direction 15a; in this position, the loading area 12 is accessible for loading. Accordingly, a respective storage surface 5 can be pushed or pulled into a second position 16 in direction 16a; in this position, the unloading area 13 is accessible for unloading. FIG. 3 shows a storage surface 5 in the loading position 15; FIG. 4 shows a storage surface 5 in the unloading position 16. In FIG. 1, by contrast, all storage surfaces 5 are shown in an intermediate position 17, in which the sheet stacks 2 are stored and the storage module 1 can be moved.

It is evident from FIGS. 1 and 2 that the respective storage surfaces 5 include grooves 20, in particular longitudinal and transverse grooves in the loading area 12 and transverse grooves in the unloading area 13. The grooves facilitate the placing and receiving of sheet stacks 2 when the latter are held on tines 48 (cf. FIGS. 3 and 4), with it being possible for the tines 48 to be oriented in the longitudinal direction 10 or in the transverse direction 11 in the loading area and in the transverse direction 11 in the unloading area 13. Since the respective storage surfaces 5 preferably include a stop 6 for the sheet stacks 2 in the unloading area 13, no longitudinal grooves are provided in the unloading area 13. The stop 6 defines the storage position of the sheet stack 2 stored first on a respective storage surface 5; all further sheet stacks 2 stored on the same storage surface 5 then strike the already previously stored sheet stacks 2.

The respective storage surfaces 5 can be equipped with locking mechanisms 21, which enable the storage surface 5 to be locked in one of its positions 15, 16 and 17. The locking mechanisms 21 can be configured for example as simple-to-operate catches, which can preferably be operated both by operating personnel and by a robot. The respective storage surfaces 5 can also be equipped with end-of-travel dampers 22, which dampen a movement of the storage surface 5 in its limit of travel of the intermediate position 17. The elements 21 and 22 are illustrated in FIG. 2 by way of example only for one storage surface 5.

It can be seen in FIGS. 1 and 2 that the respective storage surface 5 is equipped with (an array of) conveyor balls 23 on its surface area (facing the sheet stacks 2 to be stored). Alternatively, conveyor rollers or conveyor wheels could also be used. The stored sheet stacks 2 move in the direction of stop 6 automatically under their stack weight due to the inclination 18 and the conveyor balls 23. In order to limit the speed of this movement, the conveyor elements, in this case the conveyor balls 23, can be equipped with brakes 24. In order also to prevent movement of the sheet stacks 2 in the opposite direction (i.e. away from the stop 6), the conveyor elements can be provided with a respective freewheel; such an undesired movement of the sheet stacks 2 could occur when moving the storage module 1.

As can be seen from FIGS. 1 to 4, the respective storage surfaces 5 are movably disposed in the frame 4 and are movable from the storage position 17 to the “left” into the loading position 15 and to the “right” into the unloading position 16. The movement of a respective storage surface 5 can be carried out by the operating personnel; however, the movement is preferably carried out by a robot 40 or 42. In order to enable this movement, rails, for example, can be provided on the frame 4. A respective actuator 30 can also be provided for moving a respective storage surface 5. It can be provided for example as an (electric, pneumatic or hydraulic) drive or as a pivotable compression spring 31, which preferably only triggers or assists an automatic movement of the storage surface 5.

FIG. 2 also illustrates a system 50 according to the invention. It includes at least one storage module 1 according to the invention, but preferably a plurality thereof. The system 50 can also include one or more automated guided vehicles (AGVs) (only shown symbolically for illustrative purposes), which preferably drive under the storage module 1, lift it slightly and move it on the floor 74 in an automated manner. Alternatively or in addition, the system 50 can also include one or more forklift trucks 60 (of which only one tine is shown for illustrative purposes), which can also lift and move the storage module 1. Furthermore, the system 50 can include a high-bay warehouse 61, in which a plurality of empty or loaded storage modules 1 can be stored. The system 50 shown makes it possible to realize logistics for a production facility, for example a printing plant, wherein the products, for example printed products, can be stored, transported and removed from storage in a computer-controlled and automated manner and in this way a plurality of production machines, for example post press processing machines, can be coupled for smooth production.

FIG. 3 shows the automated loading of sheet stacks 2 onto a storage surface 5 in the loading position 15 thereof. For this purpose, a first robot 40 with a first working area 41 and a first robot arm 44 is present. The first working area 41 extends from a first machine 51, for example a folding machine, to the storage module 1, which during loading is preferably disposed in a docking module 53 and thus at a defined position relative to the robot. For this purpose, the docking module 53 can have for example receptacles for the casters 54. The first robot 40 takes up the sheet stacks 2 to be stored from the first machine 51 and transfers them to the storage module 1 or its storage surface 5 extended into the loading position 15. For this purpose, the first robot 40 includes a gripping tool 46 with a movable gripper 47, which is equipped with preferably two tines 48; the latter engage under the sheet stacks 2 during transport by the robot. During loading, the tines 48 can move into the grooves 20 present, with loading being possible both in the longitudinal direction 10 and in the transverse direction 11 due to the preferred orientation of the grooves; in other words, the first robot 40 rotates the gripping tool 46 into the respective orientation during loading. Preferably, only one storage surface 5 is ever extended.

The loading is effected in an automated manner, for which purpose the first robot 40 is equipped with a control unit 49. The control can preferably be effected in such a way that the first robot 40, depending on production, takes up sheet stacks 2 from the first machine 51 and stores them in the storage module 1. For this purpose, the first robot 40 can pull the respective storage surfaces 5 from their intermediate position 17 into the loading position 15 and, after loading, push them back into the intermediate position 17 again. The gripping tool 46 and the storage surface 5 can be appropriately equipped for this purpose, preferably by using available coupling elements. The control unit 49 or alternatively a superordinate controller monitors the production and storage. In particular, it monitors and electronically stores information about which sheet stacks 2 are stored in which storage modules 1, so that the sheet stacks can later be removed from storage for further production in the correct way, i.e. also in the correct sequence; this is advantageous in particular when using a plurality of storage modules 1 and/or a high-bay warehouse 61.

FIG. 4 shows the automated unloading of sheet stacks 2 from a storage surface 5 in the unloading position 16 thereof. For this purpose, a second robot 42 with a second working area 43 and a second robot arm 45 is present. The second working area 43 extends from a second machine 52, for example a gathering machine or binding machine or stitching machine, to the storage module 1, which during loading is preferably disposed in a (further) docking module 53 and thus likewise at a defined position relative to the robot. The second robot 42 takes up the sheet stacks 2 to be stored from the storage module 1 or its storage surface 5 extended into the unloading position 16 and transfers them to the second machine 52. For this purpose, the second robot 42 likewise includes a gripping tool 46 with a movable gripper 47, which is likewise equipped with preferably two tines 48. During unloading, the tines 48 can move into the grooves 20 present, with unloading being possible only in the transverse direction 11 due to the preferred orientation of the grooves; in other words, the second robot 42 rotates the gripping tool 46 into this orientation during unloading. The second robot 42 can—in a manner corresponding to the first robot 40—pull the respective storage surfaces 5 from their intermediate position 17 into the unloading position 16 and, after unloading, push them back into the intermediate position 17 again. Preferably, only one storage surface 5 is ever extended.

The first robot 40 and the second robot 42 can be of identical configuration to one another. The second robot 42 also preferably has a control unit 49, such that the unloading can also be controlled in accordance with the production or production speed. As a result of the electronically stored information about the stored sheet stacks 2 (production order) and their respective storage location (high-bay warehouse, storage module 1, storage surface 5, storage position on the storage surface 5), the correct sheet stacks 2 in the correct sequence, depending on production, can be fed to the second machine 52.

If the second machine 52 has a plurality of feeders for sheet stacks 2, it is possible for the second robot 42 to also operate a plurality of feeders or for a plurality of second robots 42 to be provided, such that a plurality of storage modules 1 can also be unloaded simultaneously. The same applies to the first machine 51 or its delivery units or delivery conveyor sections.

The following is a summary list of reference numerals and the corresponding structure used in the above description of the invention:
1 Storage module
2 Sheet stack
3 Sheet
4 Frame
5 Storage surface(s)
6 Stop
10 Longitudinal direction
11 Transverse direction
12 Loading area
13 Unloading area
14 Storage area
15 First position, loading position
15a Movement to the first position
16 Second position, unloading position
16a Movement to the second position
17 Intermediate position, in particular storage position
18 First inclination
19 Second inclination
20 Groove(s)
21 Locking mechanism, in particular catch
22 End-of-travel damper
23 Conveyor rollers, conveyor wheels or conveyor balls
24 Brake(s)
25 Freewheel
30 Actuator (for adjusting the storage surface)
31 Drive or compression spring (for adjusting the storage surface)
40 First robot
41 First working area
42 Second robot
43 Second working area
44 First robot arm
45 Second robot arm
46 Gripping tool
47 Gripper
48 Tine
49 Control unit
50 System
51 First machine, in particular folding machine
52 Second machine
53 Docking module(s)
54 Casters (of the storage module)
60 AGV or forklift truck
61 High-bay warehouse
70 Horizontal
71 Vertical
72 Inclined direction
73 Further inclined direction
74 Floor of a production facility

1. A mobile storage module for sheet stacks in at least one of a production or post press processing of printed products, the mobile storage module comprising:
at least one inclined storage surface configured to store a plurality of sheet stacks in a row;
said at least one inclined storage surface being adjustable into two different horizontal positions.

2. The mobile storage module according to claim 1, wherein said at least one inclined storage surface is adjustable into a first horizontal position being a loading position.

3. The mobile storage module according to claim 2, wherein said at least one inclined storage surface is adjustable into a second horizontal position being an unloading position.

4. The mobile storage module according to claim 3, wherein said at least one inclined storage surface is at least one of lockable in said loading position or lockable in said unloading position.

5. The mobile storage module according to claim 3, wherein said at least one inclined storage surface automatically adjusts from said loading position into an intermediate position, and said at least one inclined storage surface automatically adjusts from said unloading position into said intermediate position.

6. The mobile storage module according to claim 5, which further comprises an actuator adjusting said at least one inclined storage surface from said loading position or from said unloading position into said intermediate position.

7. The mobile storage module according to claim 6, wherein said actuator is a robot arm.

8. The mobile storage module according to claim 1, wherein said at least one inclined storage surface has a longitudinal direction and a transverse direction.

9. The mobile storage module according to claim 8, wherein said at least one inclined storage surface receives a plurality of sheet stacks in said longitudinal direction.

10. The mobile storage module according to claim 9, wherein said at least one inclined storage surface is inclined in said longitudinal direction.

11. The mobile storage module according to claim 10, wherein said at least one inclined storage surface is additionally inclined in said transverse direction.

12. The mobile storage module according to claim 1, which further comprises at least one gripper tine, said at least one inclined storage surface having at least one groove formed therein each configured to receive a respective gripper tine.

13. The mobile storage module according to claim 12, wherein said at least one groove extends in a longitudinal direction or in a transverse direction of said at least one inclined storage surface.

14. The mobile storage module according to claim 1, wherein said at least one inclined storage surface is equipped with conveyor rollers, conveyor wheels or conveyor balls for the sheet stacks.

15. The mobile storage module according to claim 1, wherein said at least one inclined storage surface includes a plurality of inclined storage surfaces.

16. A system, comprising:
at least one mobile storage module according to claim 1;
at least one first robot having a first robot arm for loading said at least one mobile storage module; and
at least one second robot having a second robot arm for unloading said at least one mobile storage module.

17. The system according to claim 16, which further comprises a docking module for said at least one mobile storage module.

18. A method for operating a system according to claim 16, the method comprising:
moving said at least one mobile storage module into a working area of said at least one first robot;
using said at least one first robot to load at least one sheet stack onto said at least one inclined storage surface in a loading position of said at least one inclined storage surface;
moving said at least one mobile storage module into a working area of said at least one second robot; and
using said at least one second robot to unload said at least one inclined storage surface in an unloading position of said at least one inclined storage surface.

19. The method according to claim 18, which further comprises using said at least one first robot arm or said at least one second robot arm to adjust said at least one inclined storage surface from said loading position into an intermediate position or to trigger an automatic adjustment of said at least one inclined storage surface from said loading position into said intermediate position.

20. The method according to claim 19, which further comprises using said at least one first robot arm or said at least one second robot arm to adjust said at least one inclined storage surface from said unloading position into said intermediate position or to trigger an automatic adjustment of said at least one inclined storage surface from said unloading position into said intermediate position.
